(19) United States
(12) Patent Application Publication
(10) Pub. No.: US 2023/0072427 A1
(43) Pub. Date: Mar. 9, 2023

(54) Method and Apparatus Including Frequency Hopping for Multi-Beam Based Repetitions

(71) Applicant: Lenovo (Singapore) Pte. Ltd., New Tech Park (SG)

(72) Inventors: Hyejung Jung, Northbrook, IL (US); Robert Love, Barrington, IL (US); Vijay Nangia, Woodridge, IL (US)

(21) Appl. No.: 17/797,715

(22) PCT Filed: Feb. 15, 2021
(86) PCT No.: PCT/IB2021/051264

§ 371 Date: Aug. 4, 2022

Related U.S. Application Data
(60) Provisional application No. 62/976,223, filed on Feb. 13, 2020.

(51) Int. Cl. H04B 1/7143; H04W 72/12; H04L 1/08

(52) U.S. Cl. CPC H04B 1/7143; H04W 72/12; H04L 1/08

(57) ABSTRACT

A method and apparatus are provided, in which scheduling information of a physical channel is received (702), where the scheduling information includes a value that defines a particular number of repetitions of a communication to be conveyed via the physical channel and information identifying a plurality of transmit beams to be used for transmitting the physical channel. A resource for use with a particular repetition of the plurality of repetitions is determined (704) based on a relative time location of the particular repetition within a particular subset of the plurality of repetitions, where the particular repetition is transmitted using a particular transmit beam of the plurality of transmit beams and the particular subset of the plurality of repetitions includes the repetitions associated with the particular transmit beam. The particular repetition of the plurality of repetitions of the physical channel is transmitted (706) based on the determined resource.

### FIELD OF THE INVENTION

The present disclosure is directed to the transmission of multiple repetitions of a communication to be conveyed including the determination of a particular resource to use in connection with each one of the multiple repetitions, which can include frequency hopping.

### BACKGROUND OF THE INVENTION

Presently, user equipment, such as wireless communication devices, communicate with other communication devices using wireless signals, such as within a network environment that can include one or more cells within which various communication connections with the network and other devices operating within the network can be supported. Network environments often involve one or more sets of standards, which each define various aspects of any communication connection being made when using the corresponding standard within the network environment. Examples of developing and/or existing standards include new radio access technology (NR), Evolved Universal Terrestrial Radio Access (E-UTRA), Long Term Evolution (LTE), Universal Mobile Telecommunications Service (UMTS), Global System for Mobile Communication (GSM), and/or Enhanced Data GSM Environment (EDGE).

In order to better support applications that can have more time sensitive communication, where both reliability and latency are an issue, there has been an increasing focus on a type of communication identified as ultra-reliable low-latency communications (URLLC). While traditionally, data reliability and latency could be traded off, so as to better support one or the other. Increasingly, applications are desiring that performance relative to both factors be simultaneously enhanced.

In some instances the traditional ways of handling the information to be communicated needs to be rethought. In order to enhance reliability, a communication can have built in automatic retransmissions, that occur prior to any indication that there was any issue with an earlier version of the transmission. Still further different ones of these retransmissions could purposely make use of different resources, such as different ones of a plurality of possible beams. This can allow a particular communication with multiple planned retransmissions to potentially better exploit different time, frequency and spatial diversities of a wireless communication channel, where it is more likely that at least some of the retransmissions will be received even if a couple of the retransmission coincided with a path that had some factor that at the time of the communication was interfering with that particular instance of the transmission.

However depending upon how the particular resources to be used with each of the retransmissions are selected, overall utilization of the available resources can become unbalanced.

The present inventors have recognized that by organizing the planned repetitions into sub-groups associated with each of the different beams being used, that a selection pattern of resources can then be applied to each of the sub-groups of repetitions, separately, based upon a relative position of the repetition in each of the subgroups, which will help to better insure that the resources selected for use relative to any particular beam can be more uniformly utilized.

### SUMMARY

The present application provides a method in a user equipment. The method includes receiving scheduling information of a physical channel, where the scheduling information includes information having a value that defines a particular number of repetitions in a plurality of repetitions of a communication to be conveyed via the physical channel and information identifying a plurality of transmit beams to be used for transmitting the physical channel, where the physical channel includes the plurality of repetitions. A resource for use with a particular repetition of the plurality of repetitions is determined based on a relative time location of the particular repetition within a particular subset of the plurality of repetitions, where the particular repetition is transmitted using a particular transmit beam of the plurality of transmit beams and the particular subset of the plurality of repetitions includes the repetitions of the physical channel associated with the particular transmit beam. The particular repetition of the plurality of repetitions of the physical channel is then transmitted based on the determined resource.

According to another possible embodiment, a user equipment is provided. The user equipment includes a transceiver that receives from a network scheduling information of a physical channel, where the scheduling information includes information having a value that defines a particular number of repetitions in a plurality of repetitions of a communication to be conveyed via the physical channel and information identifying a plurality of transmit beams to be used for transmitting the physical channel, where the physical channel includes the plurality of repetitions. The user equipment further includes a controller that determines a resource for use with a particular repetition of the plurality of repetitions based on a relative time location of the particular repetition within a particular subset of the plurality of repetitions, where the particular repetition is transmitted using a particular transmit beam of the plurality of transmit beams and the particular subset of the plurality of repetitions includes the repetitions of the physical channel associated with the particular transmit beam. The particular repetition of the plurality of repetitions of the physical channel is then transmitted via the transceiver based on the determined resource.

According to a further possible embodiment, a method in a network entity is provided. The method includes determining scheduling information of a physical channel, where the scheduling information includes information having a value that defines a particular number of repetitions in a plurality of repetitions of a communication to be conveyed by a particular user equipment via the physical channel and information identifying a plurality of transmit beams to be used by the particular user equipment for transmitting the physical channel, where the physical channel includes the plurality of repetitions. The determined scheduling information is then transmitted to the particular user equipment. A particular repetition of the plurality of repetitions of the physical channel is then received from the particular user equipment based on a determined resource, where the resource is determined for use with the particular repetition of the plurality of repetitions based on a relative time location of the particular repetition within a particular subset of the plurality of repetitions, where the particular repetition is transmitted by the particular user equipment via a particular transmit beam of the plurality of transmit beams and the particular subset of the plurality of repetitions includes the repetitions of the physical channel associated with the particular transmit beam.

According to a still further possible embodiment, a network entity is provided. The network entity includes a controller that determines scheduling information of a physical channel, where the scheduling information includes information having a value that defines a particular number of repetitions in a plurality of repetitions of a communication to be conveyed by a particular user equipment via the physical channel and information identifying a plurality of transmit beams to be used by the particular user equipment for transmitting the physical channel, where the physical channel includes the plurality of repetitions. The network entity further includes a transceiver that transmits the determined scheduling information to the particular user equipment. A particular repetition of the plurality of repetitions of the physical channel based on a determined resource is received from the particular user equipment via the transceiver, where the resource is determined for use with the particular repetition of the plurality of repetitions based on a relative time location of the particular repetition within a particular subset of the plurality of repetitions, where the particular repetition is transmitted by the particular user equipment via a particular transmit beam of the plurality of transmit beams and the particular subset of the plurality of repetitions includes the repetitions of the physical channel associated with the particular transmit beam.

These and other features, and advantages of the present application are evident from the following description of one or more preferred embodiments, with reference to the accompanying drawings.

### BRIEF DESCRIPTION OF THE DRAWINGS

FIG. 1 is a block diagram of an exemplary network environment in which the present invention is adapted to operate;

FIG. 2 is a table, which provides a redundancy version for a transmission, such as a PUSCH transmission;

FIG. 3 is a graph illustrating an exemplary frequency hopping pattern for multiple repetitions including 5 nominal repetitions for different transmit beam patterns, and more particularly frequency hopping across actual repetitions with 2 transmit beams;

FIG. 4 is a further graph illustrating an exemplary frequency hopping pattern for multiple repetitions including 5 nominal repetitions for different transmit beam patterns, and more particularly frequency hopping across nominal repetitions with 2 alternating transmit beams;

FIG. 5 is a graph illustrating exemplary transmit beam patterns and inter-slot frequency patterns with a more balanced frequency and spatial resource utilization;

FIG. 6 is a further graph illustrating exemplary transmit beam patterns and inter-slot frequency patterns with a more balanced frequency and spatial resource utilization, including a hopping pattern change;

FIG. 7 is a flow diagram in a user equipment for determining a resource for use with each of a plurality of repetitions of a communication to be conveyed via a physical channel across a plurality of transmit beams;

FIG. 8 is a flow diagram in a network entity for determining a resource for use with each of a plurality of repetitions of a communication to be conveyed by a user equipment via a physical channel across a plurality of transmit beams; and

FIG. 9 is an exemplary block diagram of an apparatus according to a possible embodiment.

### DETAILED DESCRIPTION OF THE PREFERRED EMBODIMENT(S)

While the present disclosure is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

Embodiments provide for various methods and apparatus including frequency hopping for multi-beam based repetitions.

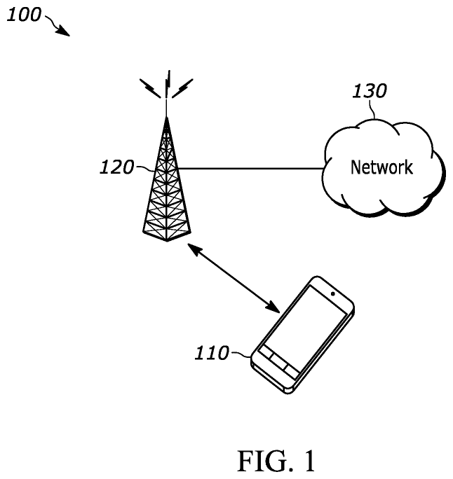

FIG. 1 is an example block diagram of a system 100 according to a possible embodiment. The system 100 can include a wireless communication device 110, such as User Equipment (UE), a base station 120, such as an enhanced NodeB (eNB) or next generation NodeB (gNB), and a network 130. The wireless communication device 110 can be a wireless terminal, a portable wireless communication device, a smartphone, a cellular telephone, a flip phone, a personal digital assistant, a personal computer, a selective call receiver, a tablet computer, a laptop computer, or any other device that is capable of sending and receiving communication signals on a wireless network.

The network 130 can include any type of network that is capable of sending and receiving wireless communication signals. For example, the network 130 can include a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 5th generation (5G) network, a 3rd Generation Partnership Project (3GPP)-based network, a satellite communications network, a high altitude platform network, the Internet, and/or other communications networks.

In radio access network (RAN)1#99 meeting, two frequency hopping schemes for physical uplink shared channel (PUSCH) repetition type B in 3rd generation partnership project (3GPP) Rel-16 new radio (NR) were agreed, but details of inter-PUSCH repetition frequency hopping were not specified.

### Agreements:

For PUSCH repetition type B, support the following frequency hopping:
   Inter-PUSCH-repetition frequency hopping (FH)
      Details for further study (FFS)
   Inter-slot FH
   FFS Intra-PUSCH-repetition FH
      In RAN#84 meeting, a new Rel-17 new radio (NR) Work Item “New WID: Further enhancements on multiple input multiple output (MIMO) for NR” (RP-193133) was approved. The work item includes the following detailed objectives:
1. Enhancement on multi-beam operation, mainly targeting frequency range (FR)2 while also applicable to FR1:
   a. Identify and specify features to facilitate more efficient (lower latency and overhead) downlink (DL)/uplink (UL) beam management to support higher intra- and layer (L)1/L2-centric inter-cell mobility and/or a larger number of configured transmission configuration indicator (TCI) states:
      i. Common beam for data and control transmission/reception for DL and UL, especially for intra-band carrier aggregation (CA)
      ii. Unified TCI framework for DL and UL beam indication
      iii. Enhancement on signaling mechanisms for the above features to improve latency and efficiency with more usage of dynamic control signaling (as opposed to radio resource control (RRC))
   b. Identify and specify features to facilitate UL beam selection for UEs equipped with multiple panels, considering UL coverage loss mitigation due to maximum permissible exposure (MPE), based on UL beam indication with the unified TCI framework for UL fast panel selection
2. Enhancement on the support for multi-transmission and reception point (TRP) deployment, targeting both FR1 and FR2:
   a. Identify and specify features to improve reliability and robustness for channels other than physical downlink shared channel (PDSCH) (that is, physical downlink control channel (PDCCH), PUSCH, and physical uplink control channel (PUCCH)) using multi-TRP and/or multi-panel, with Rel.16 reliability features as the baseline
   b. Identify and specify quasi co-location (QCL)/TCI-related enhancements to enable inter-cell multi-TRP operations, assuming multi-downlink control information (DCI) based multi-PDSCH reception
   c. Evaluate and, if needed, specify beam-management-related enhancements for simultaneous multi-TRP transmission with multi-panel reception
   d. Enhancement to support high speed train (HST)-single frequency network (SFN) deployment scenario:
      i. Identify and specify solution(s) on QCL assumption for demodulation reference signal (DMRS), e.g. multiple QCL assumptions for the same DMRS port(s), targeting DL-only transmission
      ii. Evaluate and, if the benefit over Rel.16 HST enhancement baseline is demonstrated, specify QCL/QCL-like relation (including applicable type(s) and the associated requirement) between DL and UL signal by reusing the unified TCI framework

In ultra-reliable low latency communications (URLLC), repeated UL transmissions with different UL beams can exploit time and spatial diversities of wireless channels and accordingly, may be beneficial to achieve the required reliability (e.g. 10⁻⁶ Block Error Rate) and avoid the packet loss due to channel blockage. A frequency hopping pattern properly designed for multi-beam based uplink repetition can further provide a frequency diversity gain in addition to time and spatial diversity gains.

In the present filing, frequency hopping methods that can effectively provide time, frequency, and spatial diversity gains in multi-beam based PUSCH/PUCCH repetitions and that can be directly applicable to various repetition schemes (e.g. slot-based repetition and non-slot based repetition) along with various transmit beam patterns are disclosed.

PUSCH repetition schemes and PUSCH
frequency hopping in Rel-16 NR
------------------ Extracted from TS
38.214 CR R1-1913650 ----------------------------

| | |
|---|---|
| 6.1.2 | Resource allocation |
| 6.1.2.1 | Resource allocation in time domain |

For PUSCH repetition Type A, when transmitting PUSCH scheduled by DCI format 0_1 or 0_2 in PDCCH with CRC scrambled with cell (C)-radio network temporary identifier (RNTI), modulation and coding scheme (MCS)-C-RNTI, or configured scheduling (CS)-RNTI with NDI=1, the number of repetitions K is determined as
if numberofrepetitions is present in the resource allocation table, the number of repetitions K is equal to numberofrepetitions;
elseif the UE is configured with pusch-AggregationFactor, the number of repetitions K is equal to pusch-AggregationFactor;
otherwise K=1.

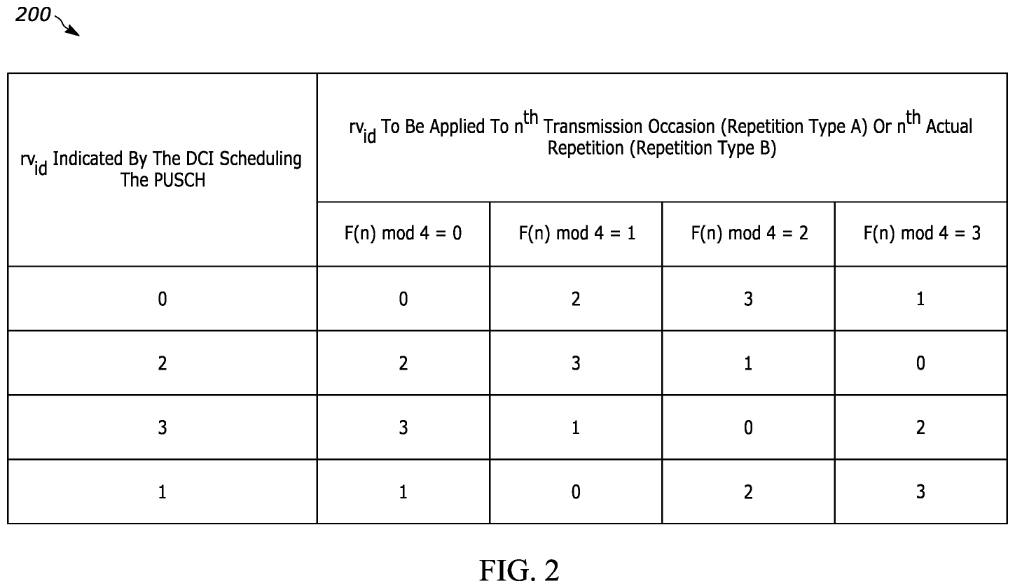

For PUSCH repetition Type A, in case K>1, the same symbol allocation is applied across the K consecutive slots and the PUSCH is limited to a single transmission layer. The UE shall repeat the transport block (TB) across the K consecutive slots applying the same symbol allocation in each slot. The redundancy version to be applied on the nth transmission occasion of the TB, where n=0, 1, . . . K-1, is determined according to table 6.1.2.1-2, Redundancy version for PUSCH transmission from TS 38.214 CR R1-1913650 illustrated as table 200 in FIG. 2.

For PUSCH repetition Type A, a PUSCH transmission in a slot of a multi-slot PUSCH transmission is omitted according to the conditions in Subclause 11.1 of [6, TS38.213].

For PUSCH repetition Type B, the number of nominal repetitions is given by numberofrepetitions. For the n-th nominal repetition, n=0, . . . , numberofrepetitions-1,
The slot where the nominal repetition starts is given by

$${K}_{s} + ⌊ \frac{S + n \cdot L}{{N}_{symb}^{slot}} ⌋ ,$$

and the starting symbol relative to the start of the slot is given by mod(S+n·L,N_{symb}^{slot}).
The slot where the nominal repetition ends is given by

$${K}_{s} + ⌊ \frac{S + ( n + 1 ) \cdot L - 1}{{N}_{symb}^{slot}} ⌋ ,$$

and the ending symbol relative to the start of the slot is given by mod(S+(n+1)·L−1,N_{symb}^{slot}).

Here Kₛ is the slot where the PUSCH transmission starts, and N_{symb}^{slot} is the number of symbols per slot as defined in Subclause 4.3.2 of [4, TS38.211].

For PUSCH repetition Type B, the UE determines invalid symbol(s) for PUSCH repetition Type B transmission as follows:
A symbol that is indicated as downlink by tdd-UL-DL-ConfigurationCommon or tdd-UL-DL-ConfigurationDedicated is considered as an invalid symbol for PUSCH repetition Type B transmission.
If a UE is configured with higher layer parameter SlotFormatInficator, the UE may be configured with the higher layer parameter InvalidSymbolPattern, which provides a symbol level bitmap spanning one or two slots (higher layer parameter symbols given by InvalidSymbolPattern). A bit value equal to 1 in the symbol level bitmap symbols indicates that the corresponding symbol is an invalid symbol for PUSCH repetition Type B transmission. The UE may be additionally configured with a time-domain pattern (higher layer parameter periodicityAndPattern given by InvalidSymbolPattern), where each bit of periodicityAndPattern corresponds to a unit equal to a duration of the symbol level bitmap symbols, and a bit value equal to 1 indicates that the symbol level bitmap symbols is present in the unit. The periodicityAndPattern can be {1, 2, 4, 5, 8, 10, 20 or 40} units long, but maximum of 40 ms. The first symbol of periodicityAndPattern every 40 ms/P periods is a first symbol in frame nf mod 4=0, where P is the duration of periodicityAndPattern in units of ms. When periodicityAndPattern is not configured, for a symbol level bitmap spanning two slots, the bits of the first and second slots correspond respectively to even and odd slots of a radio frame, and for a symbol level bitmap spanning one slot, the bits of the slot correspond to every slot of a radio frame. If InvalidSymbolPattern is configured, when the UE applies the invalid symbol pattern is determined as follows:
if InvalidSymbolPatternIndicator-ForDCIFormat0_1 is configured when the PUSCH is scheduled by DCI format 0_1, or if InvalidSymbolPatternIndicator-ForDCIFormat0_2 is configured when the PUSCH is scheduled by DCI format 0_2,
   if [invalid symbol pattern indicator] field is set 1, the UE applies the invalid symbol pattern;
   otherwise, the UE does not apply the invalid symbol pattern.
otherwise, the UE applies the invalid symbol pattern.

For PUSCH repetition Type B, after determining the invalid symbol(s) for PUSCH repetition type B transmission for each of the K nominal repetitions, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of potentially valid symbols that can be used for PUSCH repetition Type B transmission within a slot. An actual repetition is omitted according to the conditions in Subclause 11.1 of [6, TS38.213]. The redundancy version to be applied on the nth actual repetition (with the counting including the actual repetitions that are omitted) is determined according to table 6.1.2.1-2.

| | |
|---|---|
| 6.3 | UE PUSCH frequency hopping procedure |
| 6.3.1 | Frequency hopping for PUSCH repetition Type A |

For PUSCH repetition Type A (as determined according to procedures defined in Subclause 6.1.2.1 for scheduled PUSCH, or Subclause 6.1.2.3 for configured PUSCH), a UE is configured for frequency hopping by the higher layer parameter frequencyHopping-ForDCIFormat0_2 in pusch-Config for PUSCH transmission scheduled by DCI format 0_2, and by frequencyHopping provided in pusch-Config for PUSCH transmission scheduled by a DCI format other than 0_2, and by frequencyHopping provided in configuredGrantConfig for configured PUSCH transmission. One of two frequency hopping modes can be configured:
Intra-slot frequency hopping, applicable to single slot and multi-slot PUSCH transmission.
Inter-slot frequency hopping, applicable to multi-slot PUSCH transmission.
   In case of resource allocation type 1, whether or not transform precoding is enabled for PUSCH transmission, the UE may perform PUSCH frequency hopping, if the frequency hopping field in a corresponding detected DCI format or in a random access response UL grant is set to 1, or if for a Type 1 PUSCH transmission with a configured grant the higher layer parameter frequencyHoppingOffset is provided, otherwise no PUSCH frequency hopping is performed. When frequency hopping is enabled for PUSCH, the RE mapping is defined in subclause 6.3.1.6 of [4, TS 38.211].

For a PUSCH scheduled by RAR UL grant or by DCI format 0_0 with CRC scrambled by TC-RNTI, frequency offsets are obtained as described in subclause 8.3 of [9, TS 38.213]. For a PUSCH scheduled by DCI format 0_0/0_1 or a PUSCH based on a Type2 configured UL grant activated by DCI format 0_0/0_1 and for resource allocation type 1, frequency offsets are configured by higher layer parameter frequencyHoppingOffsetLists in pusch-Config. For a PUSCH scheduled by DCI format 0_2 or a PUSCH based on a Type2 configured UL grant activated by DCI format 0_2 and for resource allocation type 1, frequency offsets are configured by higher layer parameter frequencyHoppingOffsetLists-ForDCIFormat0_2 in pusch-Config.
When the size of the active bandwidth part (BWP) is less than 50 physical resource block (PRB)s, one of two higher layer configured offsets is indicated in the UL grant
When the size of the active BWP is equal to or greater than 50 PRBs, one of four higher layer configured offsets is indicated in the UL grant.

For PUSCH based on a Type1 configured UL grant the frequency offset is provided by the higher layer parameter frequencyHoppingOffset in rrc-ConfiguredUplinkGrant.

In case of intra-slot frequency hopping, the starting resource block (RB) in each hop is given by:

$${RB}_{start} = \{ \begin{matrix}R {B}_{start} & i = 0 \\ ( R {B}_{start} + {RB}_{offset} ) mod {N}_{BWP}^{size} & i = 1\end{matrix} ,$$

where i=0 and 1=1 are the first hop and the second hop respectively, and RBₛₜₐᵣₜ is the starting RB within the UL BWP, as calculated from the resource block assignment information of resource allocation type 1 (described in Subclause 6.1.2.2.2) and RB_{offset} is the frequency offset in RBs between the two frequency hops. The number of symbols in the first hop is given by [symbol] N_{symb}^{PUSCH,s}/2 [symbol] , the number of symbols in the second hop is given by N_{symb}^{PUSCH,s}- [symbol] N_{symb}^{PUSCH,s}/2 [symbol] , where N_{symb}^{PUSCH,s} is the length of the PUSCH transmission in OFDM symbols in one slot.

In case of inter-slot frequency hopping, the starting RB during slot nₛ^{μ} is given by:

$$R {B}_{s t a r t} ( {n}_{s}^{μ} ) = \{ \begin{matrix}R {B}_{s t a r t} & {n}_{s}^{μ} mod 2 = 0 \\ ( R {B}_{s t a r t} + R {B}_{offset} ) mod {N}_{BWP}^{size} & {n}_{s}^{μ} mod 2 = 1\end{matrix} ,$$

where nₛ^{μ} is the current slot number within a radio frame, where a multi-slot PUSCH transmission can take place, RBₛₜₐᵣₜ is the starting RB within the UL BWP, as calculated from the resource block assignment information of resource allocation type 1 (described in Subclause 6.1.2.2.2) and RB_{offset} is the frequency offset in RBs between the two frequency hops.

| | |
|---|---|
| 6.3.2 | Frequency hopping for PUSCH repetition Type B |

For PUSCH repetition Type B (as determined according to procedures defined in Subclause 6.1.2.1 for scheduled PUSCH, or Subclause 6.1.2.3 for configured PUSCH), a UE is configured for frequency hopping by the higher layer parameter frequencyHopping-ForDCIFormat0_2 in pusch-Config for PUSCH transmission scheduled by DCI format 0_2, by frequencyHopping-ForDCIFormat0_1 provided in pusch-Config for PUSCH transmission scheduled by DCI format 0_1, and by frequencyHopping-PUSCHRepTypeB provided in configuredGrantConfig for [Type 1] configured PUSCH transmission. [The frequency hopping mode for Type 2 configured PUSCH transmission follows the activating DCI format]. One of two frequency hopping modes can be configured:
Inter-repetition frequency hopping
Inter-slot frequency hopping

In case of resource allocation type 1, whether or not transform precoding is enabled for PUSCH transmission, the UE may perform PUSCH frequency hopping, if the frequency hopping field in a corresponding detected DCI format is set to 1, or if for a Type 1 PUSCH transmission with a configured grant the higher layer parameter frequencyHopping-PUSCHRepTypeB is provided, otherwise no PUSCH frequency hopping is performed. When frequency hopping is enabled for PUSCH, the RE mapping is defined in subclause 6.3.1.6 of [4, TS 38.211].

For a PUSCH scheduled by DCI format 0_1 or a PUSCH based on a Type 2 configured UL grant activated by DCI format 0_1 and for resource allocation type 1, frequency offsets are configured by higher layer parameter frequencyHoppingOffsetLists in pusch-Config. For a PUSCH scheduled by DCI format 0_2 or a PUSCH based on a Type 2 configured UL grant activated by DCI format 0_2 and for resource allocation type 1, frequency offsets are configured by higher layer parameter frequencyHoppingOffsetLists-ForDCIFormat0_2 in pusch-Config.
When the size of the active BWP is less than 50 PRBs, one of two higher layer configured offsets is indicated in the UL grant.
When the size of the active BWP is equal to or greater than 50 PRBs, one of four higher layer configured offsets is indicated in the UL grant.
   For PUSCH based on a Type1 configured UL grant the frequency offset is provided by the higher layer parameter frequencyHoppingOffset in rrc-ConfiguredUplinkGrant.

In case of inter-repetition frequency hopping, details to be added when agreements become available.

In case of inter-slot frequency hopping, the starting RB during slot nₛ^{μ} follows that of inter-slot frequency hopping for PUSCH Repetition Type A in Subclause 6.3.1.

### UL Beams for PUSCH Transmission

According to 3GPP TS 38.214, two transmission schemes, codebook based transmission and non-codebook based transmission, are supported for PUSCH. For PUSCH transmission(s) dynamically scheduled by an UL grant in a DCI, a UE shall upon detection of a PDCCH with a configured DCI format 0_0 or 0_1 transmit the corresponding PUSCH as indicated by that DCI.

For PUSCH scheduled by DCI format 0_0 on a cell, the UE shall transmit PUSCH according to the spatial relation, if applicable, corresponding to the physical uplink control channel (PUCCH) resource with the lowest identity (ID) within the active UL BWP of the cell, and the PUSCH transmission is based on a single antenna port. A spatial setting for a PUCCH transmission is provided by higher layer parameter PUCCH-SpatialRelationInfo if the UE is configured with a single value for higher layer parameter pucch-SpatialRelationInfold; otherwise, if the UE is provided multiple values for higher layer parameter PUCCH-SpatialRelationInfo, the UE determines a spatial setting for the PUCCH transmission based on a received PUCCH spatial relation activation/deactivation Medium Access Control (MAC) Control Element (CE) as described in [3GPP TS 38.321]. The UE applies a corresponding setting for a spatial domain filter to transmit PUCCH 3 msec after the slot where the UE transmits hybrid automatic repeat request (HARQ)-Acknowledgement (ACK) information with ACK value corresponding to a PDSCH reception providing the PUCCH-SpatialRelationInfo.

For codebook based transmission, PUSCH can be scheduled by DCI format 0_0 or DCI format 0_1. If PUSCH is scheduled by DCI format 0_1, the UE determines its PUSCH transmission precoder based on sounding reference signal resource indicator (SRI), transmit precoding matrix indicator (TPMI) and the transmission rank from the DCI, given by DCI fields of sounding reference signal (SRS) resource indicator and Precoding information and number of layers in subclause 7.3.1.1.2 of [3GPP TS 38.212]. The TPMI is used to indicate the precoder to be applied over the antenna ports {0 . . . v-1} and that corresponds to the SRS resource selected by the SRI (unless a single SRS resource is configured for a single SRS-ResourceSet set to ‘codebook’). The transmission precoder is selected from the uplink codebook that has a number of antenna ports equal to higher layer parameter nrofSRS-Ports in SRS-Config, as defined in Subclause 6.3.1.5 of [3GPP TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI before slot n. The UE determines its codebook subsets based on TPMI and upon the reception of higher layer parameter codebookSubset in PUSCH-Config which may be configured with ‘fullyAndPartialAndNonCoherent’, or ‘partialAndNonCoherent’, or ‘nonCoherent’ depending on the UE capability. The maximum transmission rank may be configured by the higher parameter maxRank in PUSCH-Config.

For non-codebook based transmission, PUSCH can be scheduled by DCI format 0_0 or DCI format 0_1. The UE can determine its PUSCH precoder and transmission rank based on the wideband SRI when multiple SRS resources are configured in a SRS resource set with higher layer parameter usage in SRS-ResourceSet set to ‘nonCodebook’, where the SRI is given by the SRS resource indicator in DCI format 0_1 according to subclause 7.3.1.1.2 of [3GPP TS 38.212] and only one SRS port is configured for each SRS resource. The indicated SRI in slot n is associated with the most recent transmission of SRS resource(s) identified by the SRI, where the SRS transmission is prior to the PDCCH carrying the SRI before slot n.

The UE shall perform one-to-one mapping from the indicated SRI(s) to the indicated DM-RS ports(s) given by DCI format 0_1 in increasing order.

In Rel-16 3GPP NR, for PUSCH scheduled by DCI format 0_0 on a cell and if the higher layer parameter enableDefaultBeamPlForPUSCH0_0 is set ‘enabled’, the UE is not configured with PUCCH resources on the active UL BWP and the UE is in RRC connected mode, the UE shall transmit PUSCH according to the spatial relation, if applicable, with a reference to the RS with ‘QCL-Type-D’ corresponding to the QCL assumption of the CORESET with the lowest ID. For PUSCH scheduled by DCI format 0_0 on a cell and if the higher layer parameter enableDefaultBeamPlForPUSCH0_0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS with ‘QCL-Type-D’ corresponding to the QCL assumption of the CORESET with the lowest ID in case CORESET(s) are configured on the component carrier (CC).

In at least one alternative proposals, inter-PUSCH-repetition frequency hopping for PUSCH repetition type B was mentioned, and frequency hopping across nominal repetitions were recommended for less resource fragmentation. However, this alternative proposal does not consider effective frequency hopping for multi-beam based PUSCH repetitions.

If a UE performs K actual PUSCH repetitions for PUSCH repetition Type B of 3GPP Rel-16 NR (according to TS 38.214) or is scheduled or configured to perform K PUSCH transmissions on K transmission occasions across the K consecutive slots for PUSCH repetition Type A of 3GPP Rel-16 NR (according to TS 38.214) with ‘N’ different UL beams according to higher-layer configuration and/or dynamic indication (e.g. DCI), frequency hopping of PUSCH repetitions can be determined such that all of configured and/or scheduled frequency hop locations for the PUSCH repetitions are utilized for each UL beam of the ‘N’ UL beams. A given UL transmit beam corresponds to one value of a spatial relation information configuration (e.g. higher layer parameter PUCCH-SpatialRelationInfo) or a TCI state (e.g. a TCI state of a CORESET, a TCI state of a PDSCH, or a TCI state of PUSCH or PUCCH). The frequency hopping methods disclosed herein are also applicable to sidelink channels and other physical channels of backhaul and access links.

In accordance with at least one embodiment of the present application, a frequency location (e.g. a starting RB) of each repetition of a physical channel (e.g. PUSCH/PUCCH) is determined based on an order of repetition (e.g. a repetition index) for a given transmit beam (e.g. a value of spatial relation information, a TCI state). That is, a UE receives scheduling information of a physical channel, where the scheduling information includes information related to a number of repetitions applied to the physical channel and one or more transmit beams used for transmitting the physical channel. The scheduling information can be received via semi-static signaling (e.g. via a RRC message) and/or dynamic signaling (e.g. DCI). For a plurality of repetitions of the physical channel scheduled (or configured), the UE identifies a plurality of subsets of the plurality of repetitions of the physical channel, where each subset of the plurality of repetitions is associated with a transmit beam of the one or more transmit beams. The UE determines a frequency resource of a particular repetition transmitted with a particular transmit beam, based on a relative time location of the particular repetition within a particular subset of the plurality of repetitions, where the particular subset of the plurality of repetitions is associated with the particular transmit beam.

For example, the relative time location is an order of the particular repetition within the particular subset of the plurality of repetitions of the physical channel. In one example, the particular subset of the plurality of repetitions comprises contiguous repetitions. In another example, the particular subset of the plurality of repetitions comprises non-contiguous repetitions.

In one implementation, in case of inter-PUSCH repetition frequency hopping, a starting RB of the PUSCH repetition k, transmitted with the UL beam i is given by:

$$R {B}_{s t a r t} ( {k}_{i} ) = \{ \begin{matrix}{RB}_{s t a r t} & {k}_{i} mod 2 = 0 \\ ( R {B}_{s t a r t} + R {B}_{offset} ) mod {N}_{BWP}^{size} & {k}_{i} mod 2 = 1\end{matrix} ,$$

where kᵢ is a PUSCH repetition index ordered within a subset of PUSCH repetitions associated with the UL beam i, i is an UL beam index, RBₛₜₐᵣₜ is the starting RB within the UL BWP, as calculated from the resource block assignment information of resource allocation type 1 (described in Subclause 6.1.2.2.2 of 38.214) and RB_{offset} is the frequency offset in RBs between the two frequency hops. In one example, the UL beam index is determined based on an order of indicated UL beams, e.g. an order of indicated TCI states, SRS resources, or spatialRelationInfo values for a PUSCH. In another example, the PUSCH repetition corresponds to an actual repetition. In an alternative example, the PUSCH repetition corresponds to a nominal repetition.

The subset of PUSCH repetitions associated with the UL beam i depends on UL beam patterns applied across PUSCH repetitions. According to one implementation, with each of the first ‘k mod N’ UL beams (mod is a modulo operator), the UE performs

$$⌈ \frac{K}{N} ⌉$$

consecutive actual repetitions (for PUSCH repetition Type B in TS 38.214) or transmits PUSCH on

$$⌈ \frac{K}{N} ⌉$$

consecutive transmission occasions (for PUSCH repetition Type A in TS 38.214), where [X] rounds X to the nearest integer no less than X. For each of the remaining (N-k mod N) UL beams, the UE performs

$$⌊ \frac{K}{N} ⌋$$

consecutive actual repetitions or transmits PUSCH on

$$⌊ \frac{K}{N} ⌋$$

consecutive transmission occasions, where [symbol] X [symbol] rounds X to the nearest integer no larger than X. In an alternate implementation, for actual repetition or transmission occasion k, k=0,1, . . . , K-1, the UE uses the UL beam n, n=0,1, . . . N-1, where

$$n = ⌊ \frac{k}{⌈ K / N ⌉} ⌋ .$$

In another implementation, consecutive actual repetitions or transmission occasions use different UL beams, for example, the UE uses the UL beam n, n=0,1, . . . N-1, for actual repetition or transmission occasion k, where n=k mod N.

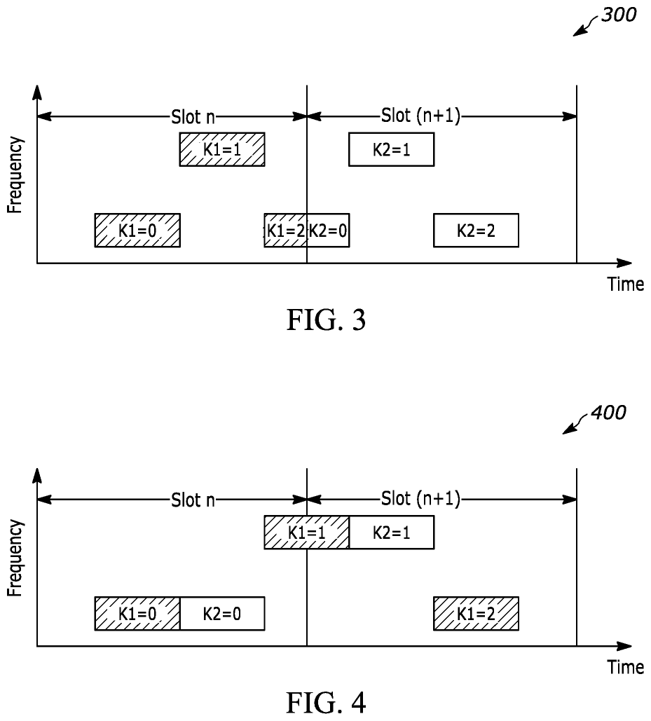

FIGS. 3 and 4 illustrate a pair of graphs 300 and 400 of an exemplary frequency hopping patterns of PUSCH comprising 5 nominal repetitions for different transmit beam patterns. More specifically, FIGS. 3 and 4 illustrate a pair of graphs 300 and 400 of an exemplary frequency hopping patterns for a PUSCH comprising five nominal repetitions according to PUSCH repetition Type B. In FIG. 3, a transmit beam and a frequency resource are determined per actual repetition. The first three actual repetitions are transmitted with a transmit beam 1 (or equivalently, TCI state 1, spatialRelationInfo value 1), and the last three actual repetitions are transmitted with a transmit beam 2 (or equivalently, TCI state 2, spatialRelationInfo value 2). A frequency resource of a given actual repetition is determined according to an order of the actual repetition within a subset of actual repetitions, such as either a set of the first three actual repetitions or a set of the last three actual repetitions. In FIG. 4, a transmit beam and a frequency resource are determined per nominal repetition. The first, third, and fifth nominal repetitions are transmitted with a transmit beam 1, and the second and fourth nominal repetitions are transmitted with a transmit beam 2. A frequency resource of a given nominal repetition is determined according to an order of the nominal repetition within a subset of nominal repetitions, such as either a set of the first, third, and fifth nominal repetitions or a set of the second and fourth nominal repetitions.

In another embodiment, in case of inter-slot frequency hopping for PUSCH repetitions with N alternating UL beams, where N is an even number, the starting RB during slot nₛ^{μ} is given by:

$$R {B}_{s t a r t} ( {\tilde{n}}_{s}^{μ} ) = \{ \begin{matrix}{RB}_{s t a r t} & {\tilde{n}}_{s}^{μ} mod 2 N = 0 , 2 , … , N - 2 , N + 1 , N + 3 , 2 N - 1 \\ ( R {B}_{s t a r t} + {RB}_{offset} ) mod {N}_{BWP}^{size} & {\tilde{n}}_{s}^{μ} mod 2 N = 1 , 3 , … , N - 1 , N , N + 2 , 2 N - 2\end{matrix} ,$$

$${\tilde{n}}_{s}^{μ} = \{ \begin{matrix}{n}_{s}^{μ} + 10 \cdot ( {n}_{f} mod 2 ) , & if μ = 0 ( i . e . for 15 KHz subcarrier spacing ) \\ {n}_{s}^{μ} , & otherwise ( i . e . for other subcarrier spacing )\end{matrix} ,$$

where nₛ^{μ} is the current slot number within the radio frame n_{f}, where a multi-slot PUSCH transmission can take place, RBₛₜₐᵣₜ is the starting RB within the UL BWP, as calculated from the resource block assignment information of resource allocation type 1 (described in Subclause 6.1.2.2.2 of 3GGP TS 38.214) and RB_{offset} is the frequency offset in RBs between the two frequency hops.

In one implementation, in case of inter-slot frequency hopping for PUSCH repetitions with two alternating UL beams, the starting RB during slot nₛ^{μ} is given by:

$${RB}_{s t a r t} ( {\tilde{n}}_{s}^{μ} ) = \{ \begin{matrix}R {B}_{s t a r t} & ; {\tilde{n}}_{s}^{μ} mod 4 = 0 , 3 \\ ( R {B}_{s t a r t} + R {B}_{offset} ) mod {N}_{BWP}^{size} & ; {\tilde{n}}_{s}^{μ} mod 4 = 1 , 2\end{matrix} ,$$

$${\tilde{n}}_{s}^{μ} = \{ \begin{matrix}{n}_{s}^{μ} + 10 \cdot ( {n}_{f} mod 2 ) & if μ = 0 ( i . e . for 15 KHz subcarrier spacing ) \\ {n}_{s}^{μ} , & otherwise ( i . e . for other subcarrier spacing )\end{matrix} ,$$

where nₛ^{μ} is the current slot number within the radio frame n_{f}, where a multi-slot PUSCH transmission can take place, RBₛₜₐᵣₜ is the starting RB within the UL BWP, as calculated from the resource block assignment information of resource allocation type 1 (described in Subclause 6.1.2.2.2 of 3GPP TS 38.214) and RB_{offset} is the frequency offset in RBs between the two frequency hops.

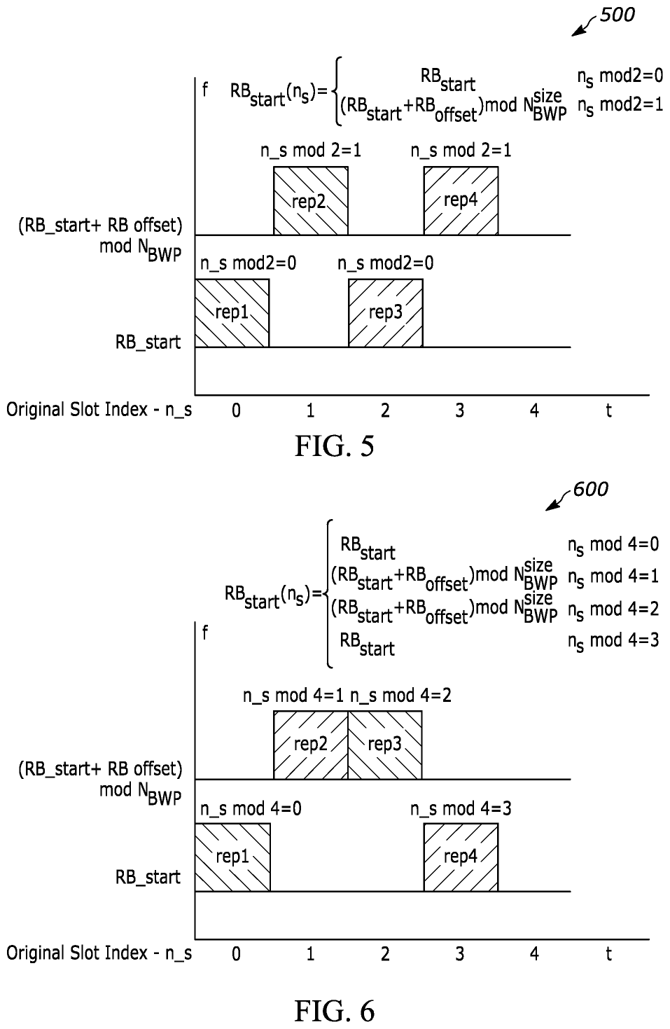

FIGS. 5 and 6 illustrate a pair of graphs 500 and 600, which are examples of transmit beam patterns and inter-slot frequency hopping patterns to achieve balanced frequency and spatial resource utilization. The proposed hopping pattern shown in FIG. 6 can provide the same degree of time and frequency diversities for all transmit beams.

In an embodiment, a redundancy version for a particular repetition of PUSCH transmission is determined based on a relative time location of the particular repetition within a particular subset of the plurality of repetitions, where the particular repetition is transmitted with a particular transmit beam and the particular subset of the plurality of repetitions is associated with the particular transmit beam.

In one example, the redundancy versions for PUSCH transmission are determined according to rules defined in a table consistent with the table illustrated in FIG. 2, where F(n) denotes a mapping function from n^{th} actual repetition or transmission occasion to an index ordered with a subset of actual repetitions or transmission occasions associated with a particular UL beam.

### Antenna Port, Quasi-Collocation and Antenna Panel

In some of the embodiments described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

An “antenna port” according to an embodiment may be a logical port that may correspond to a beam resulting from beamforming or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some embodiments, a UE antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The UE antenna panel or “UE panel” may be a logical entity with physical UE antennas mapped to the logical entity. The mapping of physical UE antennas to the logical entity may be up to UE implementation. Communicating including receiving or transmitting on at least a subset of antenna elements or antenna ports active for radiating energy also referred to herein as active elements of an antenna panel requires biasing or powering on of the RF chain which results in current drain or power consumption in the UE associated with the antenna panel including power amplifier/low noise amplifier (LNA) power consumption associated with the antenna elements or antenna ports. The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on UE's own implementation, a “UE panel” can have at least one of the following functionalities as an operational role of unit of antenna group to control its Tx beam independently, unit of antenna group to control its transmission power independently, unit of antenna group to control its transmission timing independently. The “UE panel” may be transparent to gNB. For certain condition(s), gNB or network can assume the mapping between UE's physical antennas to the logical entity “UE panel” may not be changed. For example, the condition may include until the next update or report from UE or comprise a duration of time over which the gNB assumes there will be no change to the mapping. UE may report its UE capability with respect to the “UE panel” to the gNB or network. The UE capability may include at least the number of “UE panels”. In one implementation, the UE may support UL transmission from one beam within a panel; with multiple panels, more than one beam (one beam per panel) may be used for UL transmission. In another implementation, more than one beam per panel may be supported/used for UL transmission.

In URLLC, repeated UL transmissions with different UL beams may be beneficial to achieve the required reliability and overcome channel blockage. Frequency hopping of multi-beam based UL repetitions can further provide a frequency diversity gain in addition to time and spatial diversity gains. Thus, frequency hopping methods that are applicable to various repetition schemes (e.g. slot-based repetition and non-slot based repetition) along with various transmit beam patterns need to be developed.

Frequency hopping patterns proposed in this disclosure take into account a relative time position of a particular repetition within a set of repetitions associated with a particular transmit beam. Hence, the proposed methods are directly applicable to both single-beam and multi-beam based PUSCH/PUCCH repetitions and applicable to both PUSCH repetition type A (i.e. slot-level repetition) and PUSCH repetition type B (i.e. non-slot-level repetition). In multi-beam based repetitions, the methods can provide balanced distribution of frequency resources for each transmit beam.

In current Rel-15/16 NR frequency hopping methods, a frequency resource of a PUSCH is determined based on a frequency hop index for intra-slot frequency hopping within the PUSCH or based on a slot index for inter-slot frequency hopping. Since the number of repetitions per slot may vary across slots in a non-slot based PUSCH repetition scheme (e.g. Rel-16 PUSCH repetition Type B), a slot-index based frequency hopping pattern may cause significantly unbalanced distribution of frequency resources across repetitions (e.g. a certain frequency resource to be under-utilized compared to another frequency resource).

In at least one alternative proposal, nominal repetition based inter-PUSCH-repetition frequency hopping for PUSCH repetition type B has been proposed. However, effective frequency hopping for multi-beam based PUSCH repetitions was not considered.

For a plurality of repetitions of the physical channel scheduled (or configured) for a UE, the UE identifies a subset of the plurality of repetitions of the physical channel that are associated with a particular transmit beam and determines a frequency resource of a particular repetition based on a relative time location of the particular repetition within the subset of the plurality of repetitions of the physical channel.

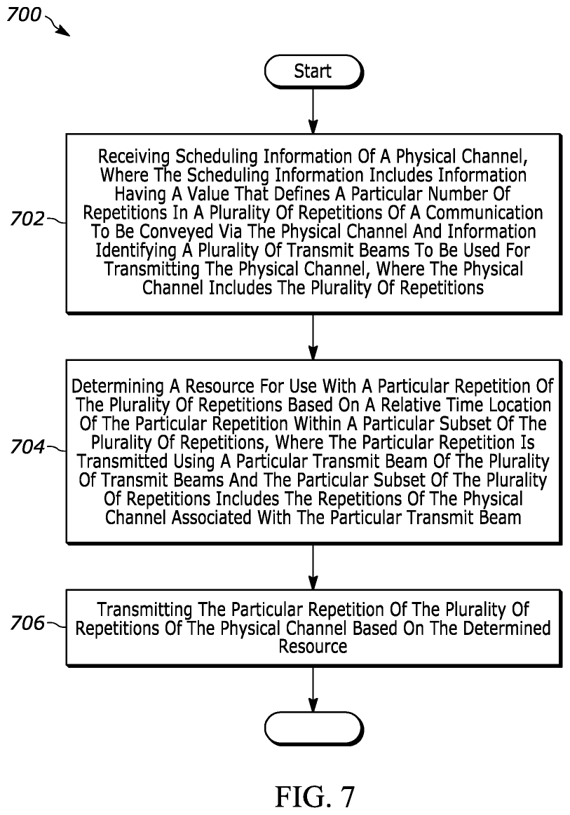

FIG. 7 illustrates a flow diagram 700 in a user equipment for determining a resource for use with each of a plurality of repetitions of a communication to be conveyed via a physical channel across a plurality of transmit beams. In accordance with at least one embodiment, the method can include receiving 702 scheduling information of a physical channel, where the scheduling information includes information having a value that defines a particular number of repetitions in a plurality of repetitions of a communication to be conveyed via the physical channel and information identifying a plurality of transmit beams to be used for transmitting the physical channel, where the physical channel includes the plurality of repetitions. A resource for use with a particular repetition of the plurality of repetitions can be determined 704 based on a relative time location of the particular repetition within a particular subset of the plurality of repetitions, where the particular repetition is transmitted using a particular transmit beam of the plurality of transmit beams and the particular subset of the plurality of repetitions includes the repetitions of the physical channel associated with the particular transmit beam. The particular repetition of the plurality of repetitions of the physical channel can then be transmitted 706 based on the determined resource.

In some instances, the method can further comprise identifying a plurality of subsets of the plurality of repetitions of the physical channel, where each subset of the plurality of repetitions is associated with a respective one of the plurality of transmit beams.

In some instances, the scheduling information can be received via at least one of semi-static signaling and dynamic signaling.

In some instances, the particular subset of the plurality of repetitions can be contiguous repetitions.

In some instances, the particular subset of the plurality of repetitions can be non-contiguous repetitions.

In some instances, the particular repetition can be a nominal repetition, where the nominal repetition comprises one or more actual repetitions.

In some instances, the particular repetition can be an actual repetition.

In some instances, the information related to the plurality of transmit beams can include at least one of a plurality of spatial relation information values, a plurality of physical downlink shared channel (PDSCH) transmission configuration indicator (TCI) states, a plurality of physical uplink shared channel (PUSCH) TCI states, and a plurality of TCI states configured for a plurality of control resource sets (CORESETs).

In some instances, the resource can be associated with a redundancy version. In at least some of these instances, the method can further include determining a redundancy version of the particular repetition based on the relative time location of the particular repetition within the particular subset of the plurality of repetitions.

In some instances, the resource can be an entry in a frequency hopping pattern corresponding to a respective one of a plurality of associated hopping frequencies.

In some instances, the communication can be an ultra-reliable low latency communication.

In some instances, the repetitions of a particular subset of the plurality of repetitions can include intra-slot repetitions.

In some instances, the repetitions of a particular subset of the plurality of repetitions can include inter-slot repetitions.

In some instances, the plurality of repetitions of the communication can correspond to a plurality of repetitions of a particular transport block.

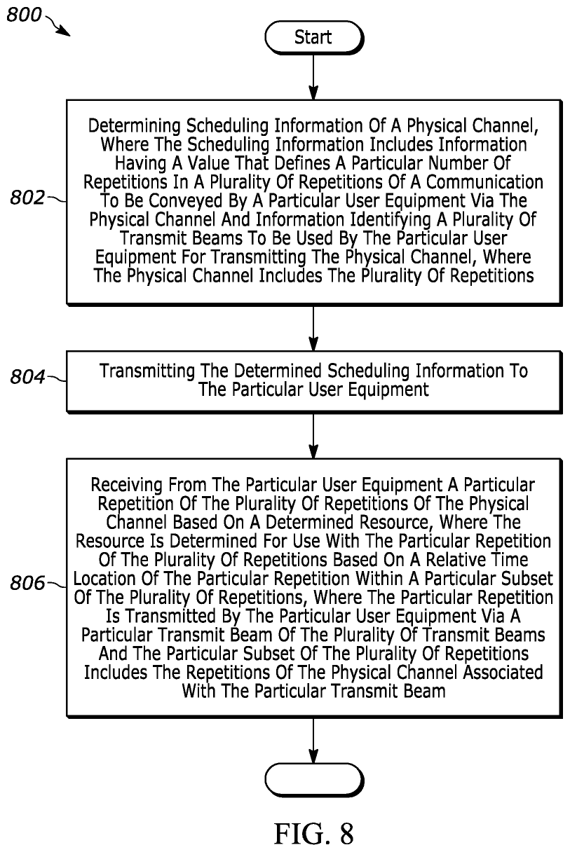

FIG. 8 illustrates a flow diagram 800 in a network entity for determining a resource for use with each of a plurality of repetitions of a communication to be conveyed by a user equipment via a physical channel across a plurality of transmit beams. In accordance with at least one embodiment, the method can include determining 802 scheduling information of a physical channel, where the scheduling information includes information having a value that defines a particular number of repetitions in a plurality of repetitions of a communication to be conveyed by a particular user equipment via the physical channel and information identifying a plurality of transmit beams to be used by the particular user equipment for transmitting the physical channel, where the physical channel includes the plurality of repetitions. The determined scheduling information can then be transmitted 804 to the particular user equipment. A particular repetition of the plurality of repetitions of the physical channel can then be received 806 from the particular user equipment based on a determined resource, where the resource is determined for use with the particular repetition of the plurality of repetitions based on a relative time location of the particular repetition within a particular subset of the plurality of repetitions, where the particular repetition is transmitted by the particular user equipment via a particular transmit beam of the plurality of transmit beams and the particular subset of the plurality of repetitions includes the repetitions of the physical channel associated with the particular transmit beam.

It should be understood that, notwithstanding the particular steps as shown in the figures, a variety of additional or different steps can be performed depending upon the embodiment, and one or more of the particular steps can be rearranged, repeated or eliminated entirely depending upon the embodiment. Also, some of the steps performed can be repeated on an ongoing or continuous basis simultaneously while other steps are performed. Furthermore, different steps can be performed by different elements or in a single element of the disclosed embodiments.

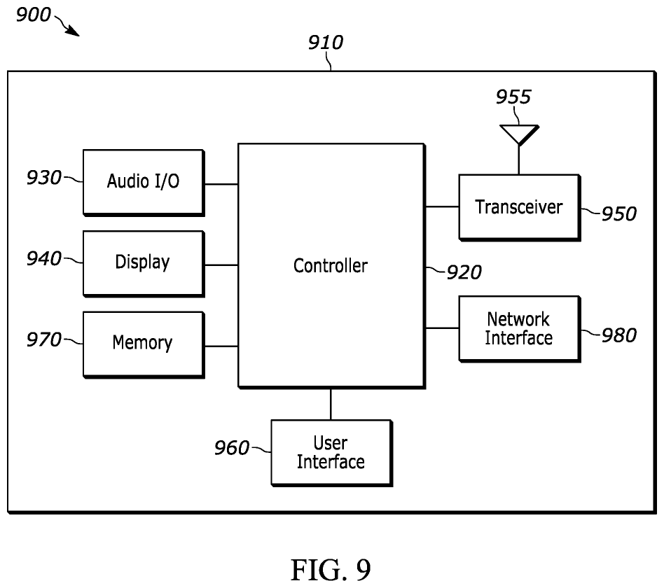

FIG. 9 is an example block diagram of an apparatus 900, such as the wireless communication device 110, according to a possible embodiment. The apparatus 900 can include a housing 910, a controller 920 within the housing 910, audio input and output circuitry 930 coupled to the controller 920, a display 940 coupled to the controller 920, a transceiver 950 coupled to the controller 920, an antenna 955 coupled to the transceiver 950, a user interface 960 coupled to the controller 920, a memory 970 coupled to the controller 920, and a network interface 980 coupled to the controller 920. The apparatus 900 can perform the methods described in all the embodiments

The display 940 can be a viewfinder, a liquid crystal display (LCD), a light emitting diode (LED) display, a plasma display, a projection display, a touch screen, or any other device that displays information. The transceiver 950 can include a transmitter and/or a receiver. The audio input and output circuitry 930 can include a microphone, a speaker, a transducer, or any other audio input and output circuitry. The user interface 960 can include a keypad, a keyboard, buttons, a touch pad, a joystick, a touch screen display, another additional display, or any other device useful for providing an interface between a user and an electronic device. The network interface 980 can be a Universal Serial Bus (USB) port, an Ethernet port, an infrared transmitter/receiver, an IEEE 1394 port, a WLAN transceiver, or any other interface that can connect an apparatus to a network, device, or computer and that can transmit and receive data communication signals. The memory 970 can include a random access memory, a read only memory, an optical memory, a solid state memory, a flash memory, a removable memory, a hard drive, a cache, or any other memory that can be coupled to an apparatus.

The apparatus 900 or the controller 920 may implement any operating system, such as Microsoft Windows®, UNIX®, or LINUX®, Android™, or any other operating system. Apparatus operation software may be written in any programming language, such as C, C++, Java or Visual Basic, for example. Apparatus software may also run on an application framework, such as, for example, a Java® framework, a .NET® framework, or any other application framework. The software and/or the operating system may be stored in the memory 970 or elsewhere on the apparatus 900. The apparatus 900 or the controller 920 may also use hardware to implement disclosed operations. For example, the controller 920 may be any programmable processor. Disclosed embodiments may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, the controller 920 may be any controller or processor device or devices capable of operating an apparatus and implementing the disclosed embodiments. Some or all of the additional elements of the apparatus 900 can also perform some or all of the operations of the disclosed embodiments.

The method of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The phrase “at least one of,” “at least one selected from the group of,” or “at least one selected from” followed by a list is defined to mean one, some, or all, but not necessarily all of, the elements in the list. The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.” Furthermore, the background section is written as the inventor's own understanding of the context of some embodiments at the time of filing and includes the inventor's own recognition of any problems with existing technologies and/or problems experienced in the inventor's own work.

What is claimed is:

1. A method in a user equipment (UE), the method comprising:
receiving scheduling information of a physical channel, where the scheduling information includes information having a value that defines a particular number of repetitions in a plurality of repetitions of a communication to be conveyed via the physical channel and information identifying a plurality of transmit beams to be used for transmitting the physical channel, where the physical channel includes the plurality of repetitions;
determining a resource for use with a particular repetition of the plurality of repetitions based on a relative time location of the particular repetition within a particular subset of the plurality of repetitions, where the particular repetition is transmitted using a particular transmit beam of the plurality of transmit beams and the particular subset of the plurality of repetitions includes the repetitions of the physical channel associated with the particular transmit beam; and
transmitting the particular repetition of the plurality of repetitions of the physical channel based on the determined resource.

2. The method of claim 1, further comprising identifying a plurality of subsets of the plurality of repetitions of the physical channel, where each subset of the plurality of repetitions is associated with a respective one of the plurality of transmit beams.

3. The method of claim 1, wherein the scheduling information is received via at least one of semi-static signaling and dynamic signaling.

4. The method of claim 1, wherein the particular subset of the plurality of repetitions are contiguous repetitions.

5. The method of claim 1, wherein the particular subset of the plurality of repetitions are non-contiguous repetitions.

6. The method of claim 1, wherein the particular repetition is a nominal repetition, where the nominal repetition comprises one or more actual repetitions.

7. The method of claim 1, wherein the particular repetition is an actual repetition.

8. The method of claim 1, wherein the information related to the plurality of transmit beams include at least one of a plurality of spatial relation information values, a plurality of physical downlink shared channel (PDSCH) transmission configuration indicator (TCI) states, a plurality of physical uplink shared channel (PUSCH) TCI states, and a plurality of TCI states configured for a plurality of control resource sets (CORESETs).

9. The method of claim 1, wherein the resource is associated with a redundancy version.

10. The method of claim 9, further comprising determining a redundancy version of the particular repetition based on the relative time location of the particular repetition within the particular subset of the plurality of repetitions.

11. The method of claim 1, wherein the resource is an entry in a frequency hopping pattern corresponding to a respective one of a plurality of associated hopping frequencies.

12. The method of claim 1, wherein the communication is an ultra-reliable low latency communication.

13. The method of claim 1, wherein the repetitions of a particular subset of the plurality of repetitions include intra-slot repetitions.

14. The method of claim 1, wherein the repetitions of a particular subset of the plurality of repetitions include inter-slot repetitions.

15. The method of claim 1, wherein the plurality of repetitions of the communication corresponds to a plurality of repetitions of a particular transport block.

16. A user equipment comprising:
a transceiver that receives from a network scheduling information of a physical channel, where the scheduling information includes information having a value that defines a particular number of repetitions in a plurality of repetitions of a communication to be conveyed via the physical channel and information identifying a plurality of transmit beams to be used for transmitting the physical channel, where the physical channel includes the plurality of repetitions; and
a controller that determines a resource for use with a particular repetition of the plurality of repetitions based on a relative time location of the particular repetition within a particular subset of the plurality of repetitions, where the particular repetition is transmitted using a particular transmit beam of the plurality of transmit beams and the particular subset of the plurality of repetitions includes the repetitions of the physical channel associated with the particular transmit beam; and
wherein the particular repetition of the plurality of repetitions of the physical channel is transmitted via the transceiver based on the determined resource.

17. The user equipment of claim 16, wherein a plurality of subsets of the plurality of repetitions of the physical channel are identified by the controller, where each subset of the plurality of repetitions is associated with a respective one of the plurality of transmit beams.

18. The user equipment of claim 16, wherein the information related to the plurality of transmit beams include at least one of a plurality of spatial relation information values, a plurality of physical downlink shared channel (PDSCH) transmission configuration indicator (TCI) states, a plurality of physical uplink shared channel (PUSCH) TCI states, and a plurality of TCI states configured for a plurality of control resource sets (CORESETs).

19. The user equipment of claim 16, wherein the resource is associated with a redundancy version, and wherein the controller determines a redundancy version of the particular repetition based on the relative time location of the particular repetition within the particular subset of the plurality of repetitions.

20. The user equipment of claim 16, wherein the resource is an entry in a frequency hopping pattern corresponding to a respective one of a plurality of associated hopping frequencies.
